(19) United States
(12) Patent Application Publication
(10) Pub. No.: US 2018/0180274 A1
(43) Pub. Date: Jun. 28, 2018

(54) AC LED LAMP WITH REPLACEABLE LED LIGHT SOURCE

(71) Applicant: Ng Ban Soon, Singapore (SG)

(72) Inventor: Ng Ban Soon, Singapore (SG)

(21) Appl. No.: 15/852,534

(22) Filed: Dec. 22, 2017

(30) Foreign Application Priority Data
Dec. 22, 2016 (CN) 201621416478.3

(51) Int. Cl. F21V 29/76; F21V 29/77; F21V 29/83; F21V 29/71; H05B 33/08

(52) U.S. Cl. CPC F21V 29/76; F21V 29/77; F21Y 2115/10; F21V 29/717; H05B 33/0809; F21V 29/83

(57) ABSTRACT

This disclosure relates to an alternating current (AC) LED lamp with a replaceable LED light source in the field of lighting. It comprises the LED light source, a light source box and a heat radiator arranged at the bottom of the light source box. As the light source box and the heat radiator adopt the dismountable and replaceable threaded connection structure according to the design, a professional repairman is not required, a user can directly dismount and replace a damaged light source box by himself/herself, and the maintenance is convenient; the plug-and-play function is realized; the cost of repairing and purchasing the lamp is saved; and moreover, the soft heat conduction sheet is additionally arranged, so that the heat of the LED light source can be smoothly conducted to the heat radiator from top to bottom.

### CROSS-REFERENCE TO RELATED APPLICATION

This application claims priority to CN201621416478.3, filed Dec. 22, 2016, the disclosure of which is hereby incorporated herein in its entirety by this reference.

### TECHNICAL FIELD

This disclosure relates to the field of lighting, and in particular, to the field of lighting lamps, and more particularly, to an alternating current (AC) LED lamp with a replaceable LED light source.

### BACKGROUND

Existing LED lamps may be divided into two kinds of LED lamps with different structures based on different power supply modes thereof. One kind of LED lamps is AC LED lamps that can be lit directly by supplied AC power; and the other kind of LED lamps is direct current (DC) lamps that are power-supplied by DC power which is converted from AC power through a driver. As the driver of the DC LED lamp is short in service life and the voltage thereof is unstable, the service life of the DC LED lamp is affected and thus relatively shorter. Therefore, the AC LED lamps will gradually replace the DC LED lamps.

The existing DC LED lamp further has the following disadvantages: 1), a heat radiator and an LED light source are fixed to form an integrated structure, and cannot be dismounted or replaced, so that the whole lamp has to be discarded after the light source is damaged, resulting in serious waste; 2), if the LED lamp is damaged and needs to be replaced, a professional repairman is required for one-site repair; but the cost of the one-site repair or replacement of the lamp by the professional repairman is relatively high, and this needs reservation in advance; and normal use of the lighting is influenced once one-site replacement is delayed; and 3), the traditional lamps are poor in heat dissipation as the heat emitted by the LED light source cannot be effectively conducted to the heat radiator, which is caused by the fact that there is a small gap between the light source and the heat radiator.

### BRIEF SUMMARY

An object of this disclosure is to overcome the above disadvantages and to provide an AC LED lamp with a replaceable LED light source. In the AC LED lamp, a damaged LED light source can be replaced conveniently, and the plug-and-play function can be realized.

The object of this disclosure is implemented through the following solutions.

The AC LED lamp with the replaceable LED light source comprises the LED light source, a light source box and a heat radiator arranged at the bottom of the light source box. The LED light source is adhered to the plane of the bottom of the inner cavity of the light source box through thermally conductive silica gel; the bottom surface of the light source box is a flat surface, so is the top surface of the heat radiator; a soft heat conduction sheet is arranged between the bottom surface of the light source box and the top surface of the heat radiator; a cylindrical plug extending vertically downwards is arranged at the center of the bottom of the light source box; a first external thread is arranged at the top end of the plug; a central through hole vertically penetrating through the heat radiator is formed in the center of the heat radiator; a cylindrical socket is mounted in the central through hole; a conductive connector for connecting a power line is arranged inside the socket; after the plug is plugged into the socket in a matched manner, the plug and the conductive connector are connected, so that power is supplied to the LED light source after the power line is connected; a second external thread is arranged at the top end of the socket; a first internal thread for threaded connection with the first external thread of the plug in a matched manner is arranged at the upper end of the central through hole; and a second internal thread for in matched threaded connection with the second external thread of the socket is arranged at the lower end of the central through hole. When mounting the light source box, the plug is plugged into the socket in a matched manner, and after the first external thread is screwed into the second external thread in a matched manner, both the bottom surface of the light source box and the top surface of the heat radiator tightly press the heat conduction sheet.

In the above description, as a preferable solution, the heat conduction sheet is a copper sheet.

In the above description, as a preferable solution, the heat conduction sheet is a silica gel heat conduction sheet.

In the above description, as a preferable solution, the left side surface and the right side surface of the light source box are provided with protruding handles for facilitating the screwing of the light source box.

In the above description, as a preferable solution, the lower end of the heat radiator is provided with a plurality of cooling fins which is combined to form a cylindrical shape.

In the above description, as a preferable solution, a lamp holder for matched mounting is arranged at the periphery of the top end of the heat radiator; and elastic hanging lugs are arranged at the two ends of the lamp holder.

In the above description, as a preferable solution, a positioning hole allowing the plug to penetrate through is formed in the center of the heat conduction sheet.

The beneficial effects of this disclosure are as follows. An AC LED chip is used as the light source, the LED light source and the light source box are combined into an integrated single module, and meanwhile, the light source box and the heat radiator are designed as the demountable and replaceable threaded connection structure, so that compared with a traditional fixed light source structure, a professional repairman is not required, and a user can directly dismount and replace a damaged light source box by himself/herself, so the maintenance is convenient, the plug-and-play function is realized, and the cost of repairing and purchasing the lamp is saved as there is no need to replace the complete set of the lamp and the user only needs to purchase the single light source box. In addition, the soft heat conduction sheet is additionally arranged; when the first external thread is screwed into the second external thread in a matched manner, in the process of tightly screwing the threads, the heat conduction sheet will be continuously pressed till the bottom surface of the light source box and the top surface of the heat radiator are tightly pressed together; the softness and the high thermal conductivity of the soft heat conduction sheet are utilized to fill the small gap between the contact surfaces of the light source box and the heat radiator, so that the heat of the LED light source can be smoothly conducted to the heat radiator from top to bottom. Finally, the socket with the conductive connector is additionally arranged, so that the LED light source is turned on after the plug is plugged into the socket in a matched manner, and the power supply of the socket is started without affecting the rotation of the threads.

### BRIEF DESCRIPTION OF THE DRAWINGS

FIG. 1 is an exploded view of a structure of this disclosure according to an embodiment;

FIG. 2 is an exploded view of a partial structure of this disclosure according to the embodiment; and

FIG. 3 is a structure view of this disclosure in an assembled state according to the embodiment.

In the figures, 1 represents an LED light source, 2 represents a light source box, 3 represents a heat radiator, 4 represents a heat conduction sheet, 5 represents a plug, 6 represents a socket, 7 represents protruding handles, 8 represents cooling fins, 9 represents a central through hole, 10 represents a second external thread, 11 represents a first external thread, 12 represents a lamp holder, and 13 represents elastic hanging lugs.

### DETAILED DESCRIPTION

This disclosure will be further described in detail below with reference to the drawings and the specific embodiments.

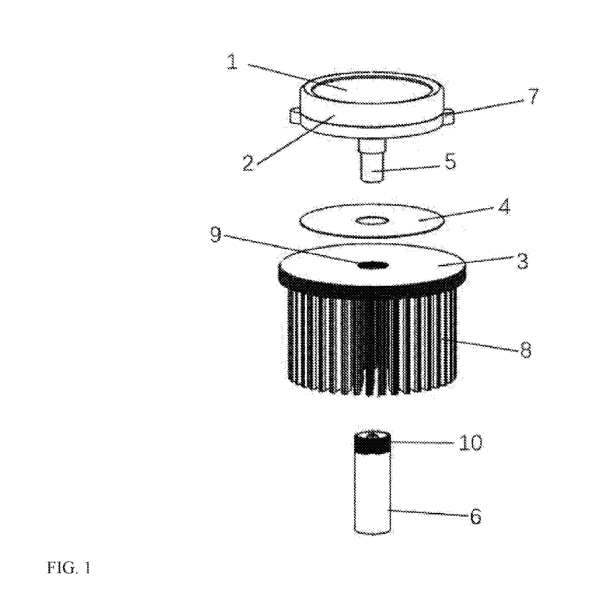

In the present embodiment, referring to FIGS. 1-3, an AC LED lamp with a replaceable LED light source 1 comprises the LED light source 1, a light source box 2 and a heat radiator 3 arranged at the bottom of the light source box 2; the LED light source 1 is adhered to the plane of the top of the light source box 2 through thermally conductive silica gel; the bottom surface of the light source box 2 is a flat surface, so is the top surface of the heat radiator 3; and a soft heat conduction sheet 4 is arranged between the bottom surface of the light source box 2 and the top surface of the heat radiator 3. In this embodiment, the heat conduction sheet 4 is a copper sheet; and a positioning hole is formed in the center of the heat conduction sheet 4.

A cylindrical plug 5 extending vertically downwards is arranged at the center of the bottom of the light source box 2; a first external thread 11 is arranged at the top end of the plug 5; a central through hole 9 vertically penetrating through the heat radiator 3 is formed in the center of the heat radiator 3; a cylindrical socket 6 is mounted in the central through hole 9; a conductive connector for connecting a power line is arranged inside the socket 6; after the plug 5 is plugged into the socket 6 in a matched manner, the plug 5 and the conductive connector are connected, so that power is supplied to the LED light source 1 after the power line is connected; a second external thread 10 is arranged at the top end of the socket 6; a first internal thread for threaded connection with the first external thread 11 of the plug 5 in a matched manner is arranged at the upper end of the central through hole 9; and a second internal thread for threaded connection with the second external thread 10 of the socket 6 in a matched manner is arranged at the lower end of the central through hole 9.

When mounting the light source box 2, the plug 5 is plugged into the socket 6 in a matched manner; when the first external thread 11 is screwed into the second external thread 10 in a matched manner, in the process of tightly screwing the threads, the heat conduction sheet 4 will be continuously pressed till the bottom surface of the light source box 2 and the top surface of the heat radiator 3 are tightly pressed together; the softness and the high thermal conductivity of the soft heat conduction sheet 4 are utilized to fill the small gap between the contact surfaces of the light source box 2 and the heat radiator 3, so that the heat of the LED light source 1 can be smoothly conducted to the heat radiator 3 from top to bottom. Finally, the socket 6 with the conductive connector is additionally arranged, so that the LED light source 1 is turned on after the plug 6 is plugged into the socket 6 in a matched manner, and the power supply of the socket 6 is started without affecting the rotation of the threads.

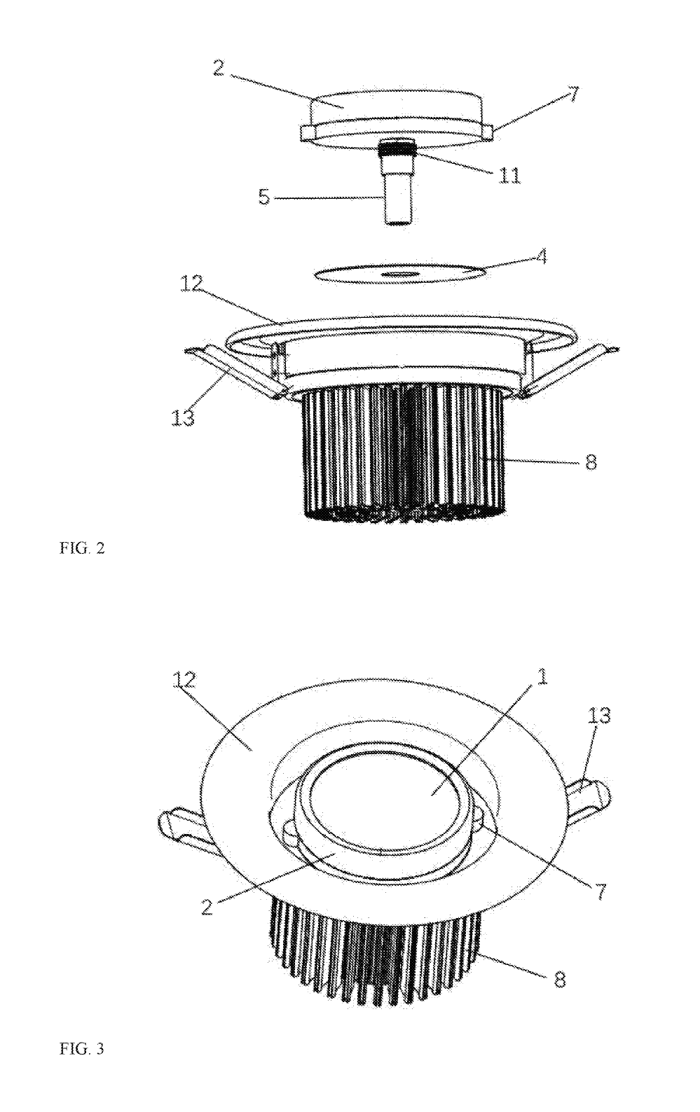

In addition, as shown in FIGS. 2 and 3, the left side surface and the right side surface of the light source box 2 are provided with protruding handles 7 for facilitating the screwing of the light source box 2, so that during dismounting or assembling the light source box 2, the user can directly hold the protruding handles 7 with the hands to swing the light source box 2 easily; the lower end of the heat radiator 3 is provided with a plurality of cooling fins 8 which is combined to form a cylindrical shape; a lamp holder 12 for matched mounting is arranged at the periphery of the top end of the heat radiator 3; and elastic hanging lugs 13 are arranged at the two ends of the lamp holder 12.

The foregoing is further detailed description of this disclosure in combination with the specific preferable embodiments, but it cannot be considered that the specific implementations of this disclosure are limited to these descriptions. For those skilled in the art, some simple deductions or replacements can be made without departing from the concept of this disclosure, and should be considered as falling in the protection scope of this disclosure.

1. An alternating current (AC) LED lamp with a replaceable LED light source, comprising:
the LED light source, a light source box and a heat radiator arranged at the bottom of the light source box, wherein the LED light source is adhered to the plane of the bottom of the inner cavity of the light source box through thermally conductive silica gel;
the AC LED lamp being characterized in that:
the bottom surface of the light source box is a flat surface, so is the top surface of the heat radiator;
a soft heat conduction sheet is arranged between the bottom surface of the light source box and the top surface of the heat radiator;
a cylindrical plug extending vertically downwards is arranged at the center of the bottom of the light source box;
a first external thread is arranged at the top end of the plug;
a central through hole vertically penetrating through the heat radiator is formed in the center of the heat radiator;
a cylindrical socket is mounted in the central through hole;
a conductive connector for connecting a power line is arranged inside the socket;
after the plug is plugged into the socket in a matched manner, the plug and the conductive connector are connected, so that power is supplied to the LED light source after the power line is connected;
a second external thread is arranged at the top end of the socket;
a first internal thread for threaded connection with the first external thread of the plug in a matched manner is arranged at the upper end of the central through hole;
a second internal thread for threaded connection with the second external thread of the socket in a matched manner is arranged at the lower end of the central through hole;
when mounting the light source box, the plug is plugged into the socket in a matched manner; and
after the first external thread is screwed into the second external thread in a matched manner, both the bottom surface of the light source box and the top surface of the heat radiator tightly press the heat conduction sheet.

2. The AC LED lamp with the replaceable LED light source according to claim 1, wherein the heat conduction sheet is a copper sheet.

3. The AC LED lamp with the replaceable LED light source according to claim 1, wherein the heat conduction sheet is a silica gel heat conduction sheet.

4. The AC LED lamp with the replaceable LED light source according to claim 1, wherein the left side surface and the right side surface of the light source box are provided with protruding handles for facilitating the screwing of the light source box.

5. The AC LED lamp with the replaceable LED light source according to claim 1, wherein the lower end of the heat radiator is provided with a plurality of cooling fins which is combined to form a cylindrical shape.

6. The AC LED lamp with the replaceable LED light source according to claim 1, wherein a lamp holder for matched mounting is arranged at the periphery of the top end of the heat radiator; and elastic hanging lugs are arranged at the two ends of the lamp holder.

7. The AC LED lamp with the replaceable LED light source according to claim 1, wherein a positioning hole allowing the plug to penetrate through is formed in the center of the heat conduction sheet.

8. The AC LED lamp with the replaceable LED light source according claim 2, wherein the left side surface and the right side surface of the light source box are provided with protruding handles for facilitating the screwing of the light source box.

9. The AC LED lamp with the replaceable LED light source according claim 3, wherein the left side surface and the right side surface of the light source box are provided with protruding handles for facilitating the screwing of the light source box.

10. The AC LED lamp with the replaceable LED light source according to claim 2, wherein the lower end of the heat radiator is provided with a plurality of cooling fins which is combined to form a cylindrical shape.

11. The AC LED lamp with the replaceable LED light source according to claim 3, wherein the lower end of the heat radiator is provided with a plurality of cooling fins which is combined to form a cylindrical shape.

12. The AC LED lamp with the replaceable LED light source according to claim 2, wherein a lamp holder for matched mounting is arranged at the periphery of the top end of the heat radiator; and elastic hanging lugs are arranged at the two ends of the lamp holder.

13. The AC LED lamp with the replaceable LED light source according to claim 3, wherein a lamp holder for matched mounting is arranged at the periphery of the top end of the heat radiator; and elastic hanging lugs are arranged at the two ends of the lamp holder.

14. The AC LED lamp with the replaceable LED light source according to claim 2, wherein a positioning hole allowing the plug to penetrate through is formed in the center of the heat conduction sheet.

15. The AC LED lamp with the replaceable LED light source according to claim 3, wherein a positioning hole allowing the plug to penetrate through is formed in the center of the heat conduction sheet.
